(19) United States
(12) Patent Application Publication
(10) Pub. No.: US 2006/0071572 A1
(43) Pub. Date: Apr. 6, 2006

(54) Stator of an electrical machine

(76) Inventors: Helmut Kunkel, Wiesthal (DE); Ingolf Groening, Lohr am Main (DE)

Correspondence Address: STRIKER, STRIKER & STENBY, 103 EAST NECK ROAD, HUNTINGTON, NY, 11743, US

(21) Appl. No.: 11/239,914

(22) Filed: Sep. 30, 2005

(30) Foreign Application Priority Data
Oct. 2, 2004 (DE) 10 2004 048 105.9

(51) Int. Cl. H02K 1/00

(52) U.S. Cl. 310/216

(57) ABSTRACT

A stator of an electrical motor has a polygonal border, a rotor opening, a plurality of channels arranged on a periphery of the rotor opening and having distances from a side defined by a shortest distance between a base of a respective one of the channels and the border, and openings provided in a region between a periphery of the rotor opening and the border and having therebetween distances defined by a shortest distance between the base of the channels and the border, the channels being arranged so that corresponding distances are selected from the group consisting of a distance from the side is substantially a maximum and a distance between one of the channels and a respective one of the openings is greater than or substantially equal to the distance from the side, the distance between one of the channels and a respective one of the openings is substantially a maximum and the distance from the side is greater than or substantially equal to the distance between the one channel and the respective one of the openings, and the distance from the side and the distance between the one channel and the respective one of the openings are substantially equal.

### BACKGROUND OF THE INVENTION

The present invention relates to the stator of an electrical machine and its manufacture.

Numerous stator cross sections for electrical machines are known from the related art. For example, document JP 9121519 A describes a stator cross section that fulfills all features of the description of the species of the present invention. This document is the most closely related art. The goal of the embodiment shown here is, by using an appropriately-selected geometry, to reduce manufacturing costs and ensure optimum material utilization.

### SUMMARY OF THE INVENTION

It is therefore an object of the present invention to provide a stator for an electrical machine that is optimized in terms of its geometry, in the case of which the best-possible utilization of installation space is ensured while improving power volume density.

It is also an object of the present invention to provide a method for implementing a suitable manufacturing process.

In keeping with these objects and with others which will become apparent hereinafter, one feature of the present invention resides, briefly stated, in a stator of an electrical motor, comprising a polygonal border; a rotor opening; a plurality of channels arranged on a periphery of said rotor opening and having distances from a side defined by a shortest distance between a base of a respective one of said channels and said border; and opens in a region between a periphery of said rotor opening and said border and having therebetween distances defined by a shortest distance between said base of said channels and said border, said channels being arranged so that corresponding distances are selected from the group consisting of a distance from the side is substantially a maximum and a distance between one of said channels and a respective one of said openings is greater than or substantially equal to the distance from said side, the distance between one of said channels and a respective one of said openings is substantially a maximum and the distance from the side is greater than or substantially equal to the distance between said one channel and said respective one of said openings and the distance from the side and the distance between said one channel and said respective one of said openings are substantially equal.

The above identified object is achieved since in the inventive stator the distance from the sides becomes a maximum or the distance between openings becomes a maximum, or the distance from the sides and the distance between the openings are equal. The distances can be realized by rotating the main region of the stator by an angle of rotation \tilde{α}

If the cross sections of the openings are negligibly small, it is sufficient to only maximize the distance from the sides and disregard the distance between openings. This is always the case automatically when the distance between the openings is greater than the distance from the sides, and remains so. A case of this type is illustrated in the table below:

| Alpha | Distance from side | Selected configuration |
|---|---|---|
| 5° | 16 | |
| 10° | 18 | |
| 15° | 20 | X |
| 20° | 16 | |

The “x” indicates the selected configuration. Given a distance from the side of 20 (the maximum value in the table), the geometry must therefore be rotated by α=15°.

If the distance between openings is smaller than the distance from the side, however, e.g, because the cross section of the opening is not negligible in this case, then it is only necessary to maximize the distance between openings.

With the optimizations mentioned previously, however, it must always be noted that the other distance not considered must not become smaller than the distance to be optimized. It should be identical or larger in size. If the distance from the side is being optimized, the distance between openings must therefore be greater than or essentially equal to the distance from the sides and, if the distance between openings is being optimized, the distance from the sides must be greater than or essentially equal to the distance between openings.

If a rectangular main region of the stator is designed with four round openings (e.g., one small bore in each corner), the ideal state results when the distance from the sides is essentially equal to the distance between the openings. Refer to the table below.

| Alpha | Distance from side | Distance between | Selected |
|---|---|---|---|
| 0° | 15 | 9 | |
| 3° | 14 | 10 | |
| 7.5° | 12 | 12 | X |
| 12° | 10 | 14 | |
| 15° | 9 | 15 | |

The “x” indicates the selected configuration. The idea angle of rotation α=7.5° results when the distance from the sides=distance between openings=12.

The distance from the sides is influenced, e.g., by the shape of the channel. When a U-shaped channel is used, e.g., the distance from the sides would be measured from the point at the channel base that is closest to the stator border. The channels are designed to accommodate copper windings, and the openings are designed for fixing the end shield on the stator. Theoretically, the channel cross sections and the opening cross sections can have any shape.

The advantage of the present invention is to ensure, via the distances selected, that the minimum stator side thickness required to operate the machine is not fallen below. The distances also serve as guide values when designing the channel and opening cross sections to obtain the optimal geometry for the design to be realized and to obtain the highest power volume density possible. The object of the present invention is essentially to optimize the magnetic circuit. The smaller the distances are, the greater the saturation is at the constrictions in the stator block created by the distances, and the greater the magnetic resistance is at these constrictions. The lesser the magnetic resistance is, however, the greater the power density is in the magnetic circuit. A mechanical rupture along the channels can also be prevented when permissible distance values are taken into consideration.

Each channel is bordered by teeth on both sides, on which windings can be installed. The windings are concentrated or distributed windings. Embodiments are feasible with which a winding is installed on each tooth, or wound teeth (poles) alternate with non-wound teeth (poles).

Advantageously, the distances between openings or the distance from the sides is determined as follows: The distances are determined for practically any hypothetical rotary position of the rotor opening, including the channels arranged on the rotor opening, relative to the cross-sectional central axis of the stator, so that an angle of rotation and an associated distance value pair (see tables above) can be determined for each rotary position. Based on the value pairs determined in this manner and assigned to an angle of rotation—each of which only represents minimum distances for the distance from a side and/or distance between openings—the essentially maximum value(s) is/are selected or, depending on the main region of the stator, the essentially identical value is selected for both distances.

With this method, a large number of distances can be theoretically determined and, depending on the stator geometry, the values for the distances from the sides and between openings can be identical for each channel due to symmetries, or they can have different values. When considering the value pairs, only minimum distances need be considered, however, since the required distances are automatically met for all other value pairs when the minimum distances considered have their maximum, because, by definition, they are above these values. Using this approach, the distances are easily determined using suitable computer-aided methods.

Particularly advantageously, an angle of rotation a is defined for the rotary position at which the practically greatest distance value of the determined minimum distances exists, or if one of the conditions mentioned previously is fulfilled. To realize the stator, it is then only necessary to inspect and/or use one angle instead of a large number of distances. In this case, “practically” means that the accuracy of the distance values must move within the magnitude of manufacturing tolerances, and it is not absolutely necessary to perform a calculation with higher resolution. Nor do the angle values need to be more accurate than is required for practical application. The rotary angle is in a range between 0° and 360°. Depending on the stator geometry and available symmetries, rotations within smaller ranges, e.g., between 0° and X°, are sufficient, whereby the value X can theoretically be any positive number, e.g., 15°, 30°, 60° or 90°.

The preferred channel cross section is polygonal, the channel base being configured in the shape of a V with legs of equal length. This results in a high power volume density.

Preferably, the stator is formed out of individual pieces of punched and laminated sheet metal that are joined and/or formed into laminated stacks via pressing, baking, laser welding or welding with flame. Losses due to eddy currents can be reduced as a result. Of course, all further methods for forming cores that are known from the related art but not mentioned here can also be used.

Particularly preferably, the stator cross section has the shape of a rectangle, in particular a square, and the openings are formed inside the corners of the rectangle as recesses or punched-out areas, and bores in particular. This results in uniform clearance from the periphery of the stator with symmetrical field distribution and the lowest possible material consumption.

Very particularly preferably, the stator is configured as a single component, to reduce the number of manufacturing steps to those that are absolutely necessary.

As an alternative, the stator can have a multiple-component configuration, e.g., by installing the teeth for accommodating windings using form-locked connections on the stator jacket. As a result, the teeth could be wound outside of the stator, which is substantially faster and easier to realize.

The use of a stator according to the present invention is advantageous with a servomotor, preferably a servomotor for robotic applications, since this is a mass-production business with large item counts, and a high power density is often required. In general, the present invention is recommended for all stators, independently of how many channels are provided.

The present invention provides a suitable manufacturing method in that the standard method for manufacturing a stator includes the following additional steps:

a) Rotate the stator around an angle a relative to its axis of symmetry;

b) Remove material.

When positioning the stator, instead of tools for creating the openings and/or channels, this manufacturing substep can be greatly simplified, since it is less complicated to rotate the stator or the pieces of sheet metal that form the stator around a certain angle than to rotate the entire punch and/or milling cutter itself. This rotation must be carried out before material can be removed. The opening (punched-out area, bore) created to accommodate the rotor, with its poles distributed around the periphery, is therefore rotated relative to the axes of symmetry of the stator cross section.

The material is preferably removed using lasers, water cutting or punching. Single-channel and complete-channel punch-outs are intended in particular.

This procedure is easily automated, and the error tolerances are minimal. Using a correctly selected angle, the required distances between channels and the sides and/or distances between openings occur automatically, when they have been selected properly. As a result, the distances do not have to be inspected or re-measured. Instead, it is only necessary to check the angles. The greatly reduces the number of working steps required.

Preferably, the angle α is in a magnitude of 360°/(4 * N), depending on the number of channels N. With a stator with N=6 channels, this therefore results in an angle α=15°. When the opening cross sections are negligible, i.e., the opening cross sections (removed stator material) are negligibly small relative to the channel cross sections, this angle results in the optimal distances between channels and walls and between openings.

As an alternative, the angle a is selected to be 0 <α<360°/(2*N) degrees. In the example described above with N=6 channels, this results in an angle α in the range from 0 up to and including 30°. This method of calculation would be preferable when the opening cross sections are no longer negligible relative to the channel cross sections.

The angle a can be any natural number or number with places to the right of the decimal within the numerical ranges described above, with limiting values 0 or 360°/(2*N) being included, and the limiting value of 360°/(2*N) can also be exceeded slightly, if necessary.

The number of channels N can be any natural number, i.e., any whole number, no negative numbers, and not zero. N is preferably calculated using the formula N=3*i, whereby i can also be any natural number. For example, the number of channels can be 3, 6, 9, 12, 15, 18, 21, 24, 27, 30, 33 or 36 channels.

The novel features which are considered as characteristic for the present invention are set forth in particular in the appended claims. the invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

The single FIGURE of the drawings is a view showing a stator of an electrical machine in accordance with the present invention.

### DESCRIPTION OF THE PREFERRED EMBODIMENTS

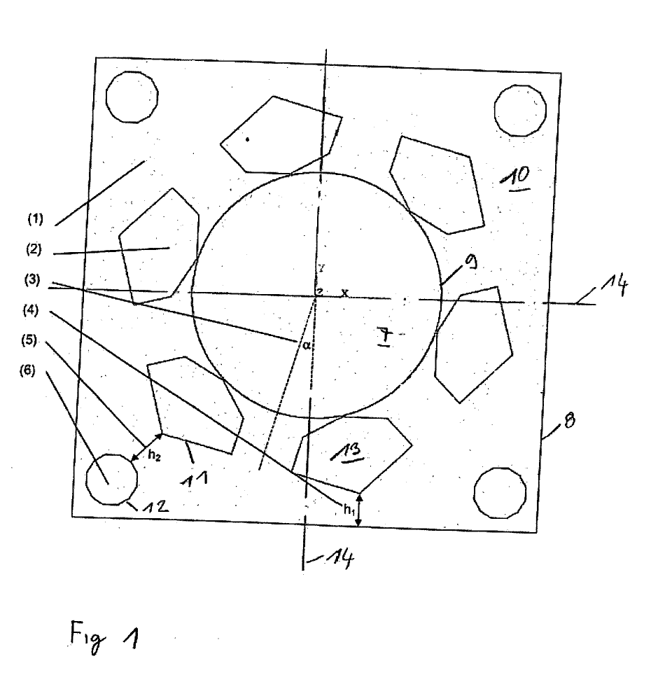

FIG. 1 shows a stator according to the present invention, formed out of stator sheets 1 with six stator channels 2, angle α 3 as indicated, and back height h1, which indicates distance from side 4 and back height 2, which indicates the distance between openings. The openings themselves are labelled with reference numeral 6.

The preferred embodiment of the present invention is a stator, formed out of stator sheets 1, for a servo drive with a square border 8, coaxial bore 7, six or more channels 2 arranged around the periphery of bore 6, the distance from the side 4 of which is defined by the shortest distance between channel base 11 and stator border 8, and recess bores 6 in main region 10 formed by bore periphery 9 and stator border 8. The distance 5 between openings is defined by the shortest distance between channel base 11 and the outer periphery 12 of bore 6. Channels 2 are arranged such that the distance from the sides 4 or distance 5 between openings is a maximum, or both values are identical.

In the figure, channel cross sections 13 are configured polygonal in shape, and channel base 11 is configured in the shape of a V with legs of equal length, so that the shortest distance (distance from the side/distance between openings) is measured between the point formed by two legs and stator periphery 8 and recess periphery 12.

Angle α (3) shown in FIG. 1 indicates the number of degrees by which a piece of laminated stator sheet 1 would have to be rotated before channels 13 and recesses 6 can be punched out. The angle was determined based on a large number of distances from sides and between openings and, in fact, such that the angle of rotation α is determined for the rotary position at which the practically greatest distance value from a list of determined minimum values of distances from the side and/or between channels exists, given the prerequisite that the particular distance value not considered is identical to or greater than the distance value under consideration.

It will be understood that each of the elements described above, or two or more together, may also find a useful application in other types of constructions differing from the types described above.

While the invention has been illustrated and described as embodied in a stator of an electrical machine, it is not intended to be limited to the details shown, since various modifications and structural changes may be made without departing in any way from the spirit of the present invention.

Without further analysis, the reveal will so fully reveal the gist of the present invention that others can, by applying current knowledge, readily adapt it for various applications without omitting features that, from the standpoint of prior art, fairly constitute essential characteristics of the generic or specific aspects of the invention.

What is claimed as new and desired to be protected by Letters Patent is set forth in the appended claims.

1. A stator of an electrical motor, comprising a polygonal border; a rotor opening; a plurality of channels arranged on a periphery of said rotor opening and having distances from a side defined by a shortest distance between a base of a respective one of said channels and said border; and openings provided in a region between a periphery of said rotor opening and said border and having therebetween distances defined by a shortest distance between said base of said channels and said border, said channels being arranged so that corresponding distances are selected from the group consisting of a distance from the side is substantially a maximum and a distance between one of said channels and a respective one of said openings is greater than or substantially equal to the distance from said side, the distance between one of said channels and a respective one of said openings is substantially a maximum and the distance from the side is greater than or substantially equal to the distance between said one channel and said respective one of said openings, and the distance from the side and the distance between said one channel and said respective one of said openings are substantially equal.

2. A stator as defined in claim 1, wherein said distances between said channels and said openings and said distances from the sides are determined for every rotary position of said rotor opening, including said channels being arranged on said rotor opening, relative to a cross-sectional central axis of the stator, and based on values obtained in this manner, each of which represents minimum distances for the distance from the side or the distance between said channels and said openings, the essentially maximum values or essentially equal values or at least one essential maximum value is selected.

3. A stator as recited in claim 2, wherein an angle of rotation is defined for a rotary position at which a substantially greatest distance value or substantially equal distance values from all the minimum distances exist.

4. A stator as defined in claim 1, wherein each of said channels has a polygonal cross-section with a channel base configured in a shape of V with legs of equal length.

5. A stator as defined in claim 1, wherein the stator is composed of individual pieces of punched and laminated sheet metal.

6. A stator as defined in claim 1, wherein the stator has a cross-section with a shape of a rectangle, and said openings are formed inside corners of said rectangle as punched-out areas or recesses.

7. A stator as defined in claim 6, wherein said cross-section of said stator has a shape of a square, and said openings are formed as bores.

8. A stator as defined in claim 1, wherein the stator is configured as a single component.

9. A stator as defined in claim 1, wherein said stator has a multiple-component configuration.

10. A stator as defined in claim 1, wherein said stator is configured as a stator for a servomotor.

11. A stator as defined in claim 1, wherein said stator is configured as a servomotor for robotic applications.

12. A method for manufacturing a stator, including a polygonal border; a rotor opening; a plurality of channels arranged on a periphery of said rotor opening and having distances from a side defined by a shortest distance between a base of a respective one of said channels and said border; and openings provided in a region between a periphery of said rotor opening and said border and having therebetween distances defined by a shortest distance between said base of said channels and said border, said channels being arranged so that corresponding distances are selected from the group consisting of a distance from the side is substantially a maximum and a distance between one of said channels and a respective one of said openings is greater than or substantially equal to the distance from said side, the distance between one of said channels and a respective one of said openings is substantially a maximum and the distance from the side is greater than or substantially equal to the distance between said one channel and said respective one of said openings and the distance from the side and the distance between said one channel and said respective one of said openings are substantially equal, the method comprising the steps of moving the stator around an angle of rotation relative to a cross-sectional central axis of the stator; and removing a corresponding material so as to form the rotor opening, the channels, and the openings.

13. A method as defined in claim 12, wherein the angle of rotation is of a magnitude 360°/(4*N), wherein N is any natural number.

14. A method as defined in claim 12, wherein the angle is in a numerical range from and including 0 to and including 360°(2*N), wherein N is any natural number.
